(19) United States
(12) Patent Application Publication
(10) Pub. No.: US 2001/0019442 A1
(43) Pub. Date: Sep. 6, 2001

(54) Optical RZ signal generator, optical RZ signal generating method, optical time division multiplexer, and optical time division multiplexing method

(76) Inventors: Makoto Shikata, Yokohama (JP); Shigeru Takasaki, Tokyo (JP)

Correspondence Address: Venable, P.O. Box 34385, Washington, DC, 20043-9998, US

(21) Appl. No.: 09/796,763

(22) Filed: Mar. 2, 2001

(30) Foreign Application Priority Data
Mar. 6, 2000 (JP) 060962/2000
Nov. 9, 2000 (JP) 2000-341729

(51) Int. Cl. H04J 14/08; H04B 10/04

(52) U.S. Cl. 359/181; 359/135

(57) ABSTRACT

To achieve an optical RZ signal generator having a simple constitution in which the number of components is significantly reduced in comparison with a conventional one, an optical RZ signal generator according to the present invention comprises a steady-state power laser light source 103 and a Mach-Zehnnder optical modulator 104 for performing intensity modulation on the basis of an electric signal supplied from an electric data signal input terminal 101 with being connected to an output of the steady-state power laser light source 103. The electric signal is a binary voltage signal and insertion loss of the Mach-Zehnnder optical modulator is preset so as to shift from a first state to a second state other than the first one and then returns to the first state in a logic level transition process of the binary voltage signal.

### BACKGROUND OF THE INVENTION

1. Field of the Invention

The present invention relates to a device for generating an optical RZ (return to zero) signal by converting an electric signal electrically and optically and to a device for generating an optical time division multiplexed signal for a time division multiplexing communication using this optical signal.

2. Related Background Art

Along with a fast spread of an optical network, there is a need for an optical RZ signal generator suitable for a long-distance mass-storage optical communication system.

A constitution for generating this optical RZ signal is disclosed in, for example, “Single-Channel 40 Gb/s Optical Soliton Transmission Using Periodic Distributed Compensation” by Itsuro Morita, Masatoshi Suzuki, Noboru Edagawa, Syu Yamamoto, and Shigeyuki Akiba (i97 General Conference of IEICE (The Institute of Electronics, Information and Communication Engineers), B-10-157, p.666).

Referring to FIG. 22, there is shown a block diagram illustrating a constitution of a conventional optical RZ signal generator. The device shown in FIG. 22 has an electric data signal input terminal 2201, an electric clock signal input terminal 2202, and an optical output pot 2203 as input or output terminals.

Among them there are provided a steady-state power laser light source 2204, an electro-absorption semiconductor optical modulator 2205, an optical amplifier 2206, and Mach-Zehnnder optical modulator 2207.

The electric data signal input terminal 2201 is connected to an electric signal input terminal of the Mach-Zehnnder optical modulator 2207 and the electric clock signal input terminal 2202 is connected to an electric signal input terminal of the electro-absorption semiconductor optical modulator 2205.

Additionally an output port of the steady-state power laser light source 2204 is connected to an optical signal input port of the electro-absorption semiconductor optical modulator 2205. An optical signal output port of the electro-absorption semiconductor optical modulator 2205 is connected to an optical signal input port of the optical amplifier 2206. An optical signal output port of the optical amplifier 2206 is connected to an optical signal input port of the Mach-Zehnnder optical modulator 2207. Furthermore, an optical signal output port of the Mach-Zehnnder optical modulator 2207 is connected to the optical signal output port 2203.

A binary voltage signal for performing intensity modulation is inputted to the electric data signal input terminal 2201 and an electric signal of a sinusoidal wave is inputted to the electric clock signal input terminal 2202.

In this constitution, a certain power laser light outputted from the steady-state power laser light source 2204 is modulated by the electro-absorption semiconductor optical modulator 2205 so as to be a continuous RZ optical pulse train. This RZ optical pulse train is amplified by the optical amplifier 2206, encoded by the Mach-Zehnnder optical modulator 2207 on the basis of the binary voltage signal, and then outputted as an optical RZ signal from the optical signal output port 2203.

In addition, along with a fast spread of the above optical network, an optical time division multiplexing technology for using a limited band with more channels is drawing public attention. The time division multiplexing allows a limited band to be used by more channels by dividing a single signal band into fine time slots each having a predetermined time interval and allocating different channels to respective time slots.

This optical time division multiplexing technology is also disclosed in the above literature.

Referring to FIG. 23, there is shown a block diagram illustrating a constitution of a conventional optical time division multiplexer. The device shown in FIG. 23 has a constitution in which first and second two time slots are provided in a single signal band for time division multiplexing.

This optical time division multiplexer has a first electric data signal input terminal 2301, a second electric data signal input terminal 2302, an electric clock signal input terminal 2303, and an optical output port 2304 as input or output terminals.

Among them there are provided a steady-state power laser light source 2305, an electro-absorption semiconductor optical modulator 2306, an optical amplifier 2307, an optical branching filter 2308, a first Mach-Zehnnder optical modulator 2309, a second Mach-Zehnnder optical modulator 2310, and an optical combiner 2311.

The first electric data signal input terminal 2301 is connected to an electric signal input terminal of the first Mach-Zehnnder optical modulator 2309, the second electric data signal input terminal 2302 is connected to an electric signal input terminal of the second Mach-Zehnnder optical modulator 2310, and the electric clock signal input terminal 2303 is connected to an electric signal input terminal of the electro-absorption semiconductor optical modulator 2306.

In addition an output port of the steady-state power laser light source 2305 is connected to an optical signal input port of the electro-absorption semiconductor optical modulator 2306. An optical signal output port of the electro-absorption semiconductor optical modulator 2306 is connected to an optical signal input port of the optical amplifier 2307. An optical signal output port of the optical amplifier 2307 is connected to an optical signal input port of the optical branching filter 2308.

The optical branching filter 2308 has a first optical signal output port and a second optical signal output port; the first optical signal output port is connected to an optical signal input port of the first Mach-Zehnnder optical modulator 2309 and the second optical signal output port is connected to an optical signal input port of the second Mach-Zehnnder optical modulator 2310.

An optical signal output port of the first Mach-Zehnnder optical modulator 2309 is connected to a first optical signal input port of the optical combiner 2311 and in the same manner an optical signal output port of the second Mach-Zehnnder optical modulator 2310 is connected to a second optical signal input port of the optical combiner 2311. The optical signal output port of the optical combiner 2311 is connected to the optical output port 2304.

A first binary voltage signal for performing intensity modulation corresponding to a signal of a first time slot is inputted to the first electric data signal input terminal 2301, a second binary voltage signal for performing intensity modulation corresponding to a signal of a second time slot, and an electric signal of a sinusoidal wave synchronized with the first or second binary voltage signal is inputted as a clock signal to the electric clock signal input terminal 2303.

By using this constitution, a certain power laser light outputted from the steady-state power laser light source 2305 is modulated by the electro-absorption semiconductor optical modulator 2306 so as to be a continuous optical pulse train. This optical pulse train is amplified by the optical amplifier 2307 and then branched to two optical signals by the optical branching filter 2308.

One of the branched optical signals is encoded by the first Mach-Zehnnder optical modulator 2309 on the basis of the first binary voltage signal, the other is encoded by the second Mach-Zehnnder optical modulator 2310 on the basis of the second binary voltage signal, and these two encoded optical signals are combined again by the optical combiner 2311.

At this time there is preset a delay difference equal to one-half of a period of the above clock signal between these two encoded optical signals to be combined. As a result, the combined optical signal is output from the optical output port 2304 as a time division multiplexed optical signal having an optical signal made by encoding the first binary voltage signal in the first time slot and an optical signal made by encoding the second binary voltage signal in the second time slot.

The conventional optical RZ signal generator shown in FIG. 22, however, has a constitution in which a continuous RZ optical pulse train generated by the electro-absorption semiconductor optical modulator 2205 is amplified by the optical amplifier 2206 before it is modulated by the Mach-Zehnnder optical modulator 2207, which causes a problem that a large number of components are required for manufacturing the device. Additionally a generation of RZ optical pulses using the electro-absorption semiconductor optical modulator 2205 causes a problem that a width of an optical pulse depends strongly upon unevenness of characteristics of the electro-absorption semiconductor optical modulator 2205 or that an output optical RZ signal has chirping.

Furthermore the conventional optical RZ signal generator shown in FIG. 22 generates an optical RZ signal having the same bit cycle as that of the binary voltage signal inputted to the electric data signal input terminal 2201, by which it is necessary to increase a bit rate of the binary voltage signal inputted to the electric data signal input terminal 2201 in order to achieve an optical RZ signal having a higher bit rate. This causes a problem of an increase of a load on an electric circuit for generating a binary voltage signal inputted to the electric data signal input terminal 2201 along with a tendency of an enhanced mass storage of an optical network.

On the other hand, for the conventional optical time division multiplexer shown in FIG. 23, there is a need for reducing a pulse width of the continuous optical pulse train generated by the electro-absorption semiconductor optical modulator 2306 up to one-eighth to one-tenth of the pulse period in order to suppress interference between optical pulses which may occur when the optical signals are combined again by the optical combiner 2310.

Therefore, disadvantageously the multiplexed optical signal has a wide optical band, thereby decreasing a tolerance for a wavelength dispersion and further lowering a band utilization efficiency in the wavelength division multiplexing transmission.

In addition, there has been a problem of chirping included in a continuous optical pulse train generated by the electro-absorption semiconductor optical modulator 2306. It results in a need for suppressing the chirping in encoding the optical signals using the first Mach-Zehnnder optical modulator 2309 and the second Mach-Zehnnder optical modulator 2310, thereby requiring a wide band for the first binary voltage signal and the second binary voltage signal. This leads to a problem of an increase of a load on the electric circuit for generating the first binary voltage signal and the second binary voltage signal.

Furthermore, there is a need for providing the optical amplifier 2307 for compensating a loss of the electro-absorption semiconductor optical modulator 2306 in addition to the optical branching filter 2308 and the optical combiner 2311 for branching or combining waves, thereby causing a problem of increasing the number of the components.

### SUMMARY OF THE INVENTION

To resolve the above problems, an optical RZ signal generator according to the present invention comprises a steady-state power laser light source and a Mach-Zehnnder optical modulator for performing intensity modulation on the basis of an electric signal with being connected to an output of the steady-state power laser light source. The electric signal is a binary voltage signal and an insertion loss state of the Mach-Zehnnder optical modulator is preset so as to change from a first state to a second state other than the first one and to return to the first state in a logic level transition process of the binary voltage signal.

In addition, an optical time division multiplexer according to the present invention comprises a steady-state power laser light source, a first external intensity modulator for performing intensity modulation on the basis of a first electric signal during a period corresponding to a first time slot with being connected to an output of the steady-state power laser light source, and a second external intensity modulator for performing intensity modulation on the basis of a second electric signal during a period corresponding to a second time slot.

### BRIEF DESCRIPTION OF THE DRAWINGS

FIG. 1 is a block diagram illustrating a constitution of an optical RZ signal generator according to a first embodiment of the present invention;

FIG. 2 is a block diagram illustrating a constitution of a Mach-Zehnnder optical modulator 104 applied to the first embodiment;

FIG. 3 is a timing chart of assistance in explaining an operation of the first embodiment;

FIG. 4 is a block diagram illustrating a constitution of the optical RZ signal generator according to a second embodiment of the present invention;

FIG. 5 is a timing chart of assistance in explaining an operation of the second embodiment;

FIG. 6 is a block diagram illustrating a constitution of an optical RZ signal generator according to a third embodiment of the present invention;

FIG. 7 is a block diagram illustrating a constitution of a Mach-Zehnnder optical modulator applied to the third embodiment;

FIG. 8 is a timing chart of assistance in explaining an operation of the third embodiment;

FIG. 9 is a block diagram illustrating a constitution of an optical RZ signal generator according to a fourth embodiment of the present invention;

FIG. 10 is a timing chart of assistance in explaining an operation of the fourth embodiment;

FIG. 11 is a block diagram illustrating a constitution of an optical RZ signal generator according to a fifth embodiment of the present invention;

FIG. 12 is a block diagram illustrating a constitution of a Mach-Zehnnder optical modulator applied to the fifth embodiment;

FIG. 13 is a timing chart of assistance in explaining an operation of the fifth embodiment;

FIG. 14 is a block diagram illustrating a constitution of an optical RZ signal generator according to a sixth embodiment of the present invention;

FIG. 15 is a timing chart of assistance in explaining an operation of the sixth embodiment;

FIG. 16 is a diagram showing an optical output waveform according to a sixth embodiment;

FIG. 17 is a block diagram illustrating a constitution of an optical time division multiplexer according to a seventh embodiment of the present invention;

FIG. 18 is a block diagram illustrating a constitution of a differentially-driving Mach-Zehnnder optical modulator applied to the seventh embodiment;

FIG. 19 is a timing chart of assistance in explaining an operation of the seventh embodiment;

FIG. 20 is a diagram showing an optical output waveform of the seventh embodiment;

FIG. 21 is a constitutional diagram in which the present invention is applied to an optical time division multiplexer having a first to an nth time slots;

FIG. 22 is a block diagram illustrating a constitution of a conventional optical TZ signal generator; and

FIG. 23 is a block diagram illustrating a constitution of a conventional optical time division multiplexer.

### DETAILED DESCRIPTION OF THE PREFERRED EMBODIMENTS

[First Embodiment]

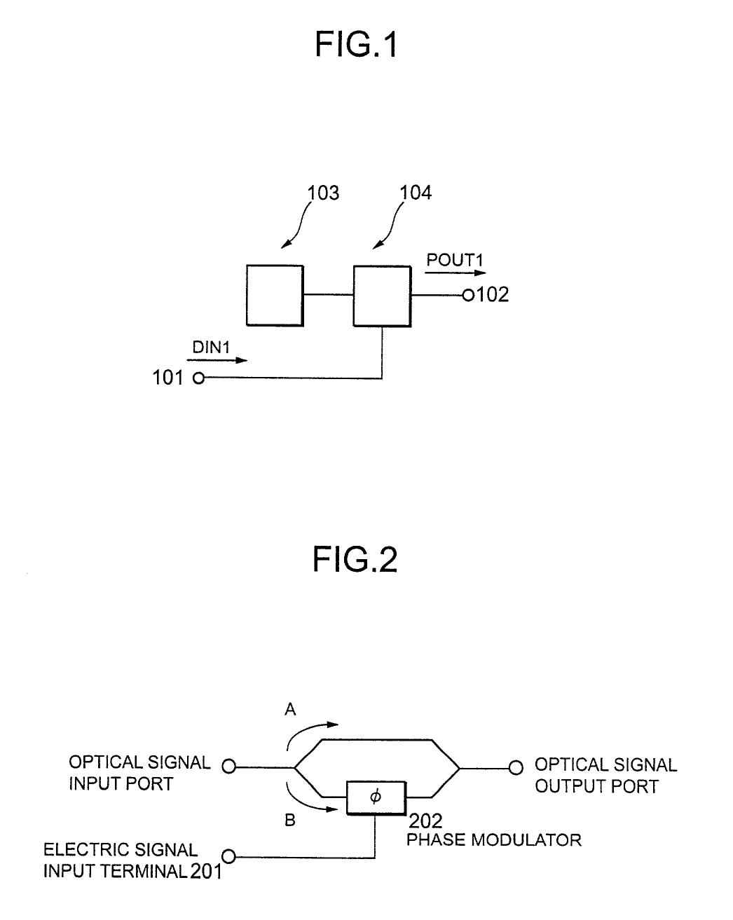

Referring to FIG. 1, there is shown a block diagram of a first embodiment of an optical RZ signal generator according to the present invention. The optical RZ signal generator shown in FIG. 1 has an electric data signal input terminal 101 and an optical output port 102 as input or output terminals. A steady-state power laser light source 103 and a Mach-Zehnnder optical modulator 104 are provided among them.

The electric data signal input terminal 101 is connected to an electric signal input terminal of the Mach-Zehnnder optical modulator 104 and an optical signal output port of the steady-state power laser light source 103 is connected to an optical signal input port of the Mach-Zehnnder optical modulator 104. Furthermore an optical signal output port of the Mach-Zehnnder optical modulator 104 is connected to the optical output port 102.

Referring to FIG. 2, there is shown a constitutional diagram of the Mach-Zehnnder optical modulator 104 used in the first embodiment of the optical RZ signal generator. As shown in this diagram, this electric signal input terminal 201 is connected to a phase modulator 202 arranged in the optical path (B) side of a Mach-Zehnnder interferometer.

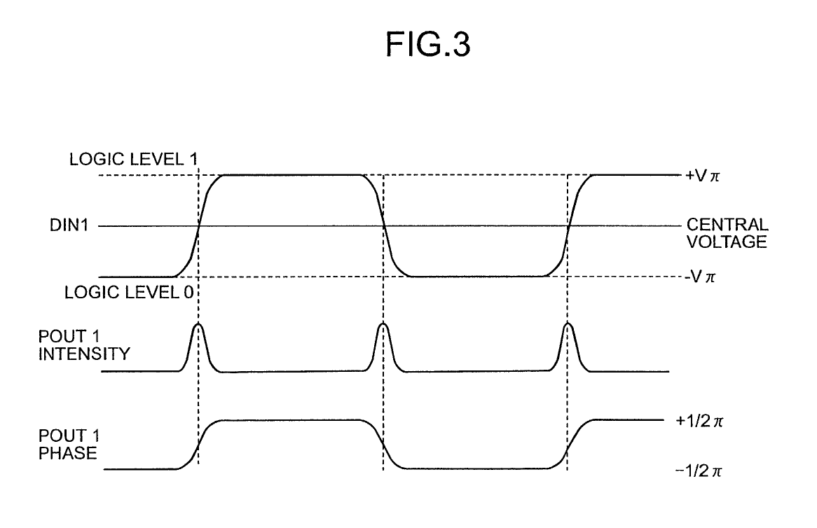

Referring to FIG. 3, there is shown a timing chart of assistance in explaining an operation of this embodiment.

A binary voltage signal DIN1 for performing intensity modulation is inputted to the electric data signal input terminal 101. An amplitude of this binary voltage signal is twice that of a voltage Vp required for p modulation, namely, for π(180 deg) modulation of a phase of a light propagating in the optical path (B) side on which the phase modulator 201 is arranged shown in FIG. 2 of the Mach-Zehnnder optical modulator 104.

A central voltage of the binary voltage signal DIN1 is preset to a voltage at which there is no phase difference between two optical paths in the Mach-Zehnnder optical modulator 104 so that insertion loss is minimized.

As a result, if the binary voltage signal DIN1 has “a voltage corresponding to a logic level 0” (hereinafter referred to as logic level 0) or “a voltage corresponding to a logic level 1” (hereinafter referred to as logic level 1), the Mach-Zehnnder optical modulator 104 has the maximum insertion loss.

If the binary voltage signal DIN1 shifts from the logic level 0 to the logic level 1 or from logic level 1 to the logic level 0, the binary voltage signal DINI passes through the above central voltage in the transition process. As a result, the insertion loss of the Mach-Zehnnder optical modulator 104 is sequentially put in the first maximum state, the second minimum state, and then the maximum state again.

In this constitution, the optical output port 102 outputs a signal POUT1 having an optical pulse at the logic level transition of the binary voltage signal DIN1.

As apparent from the above description, the constitution of this embodiment allows an optical RZ signal generator to comprise the steady-state power laser light source 103 and the Mach-Zehnnder optical modulator 104, thereby significantly reducing the number of components in comparison with the conventional one.

[Second Embodiment]

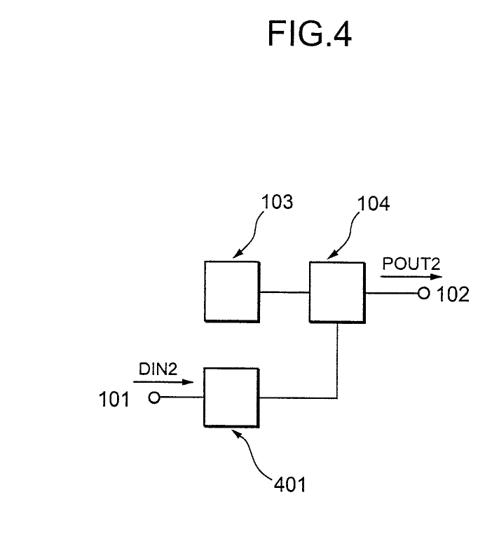

Referring to FIG. 4, there is shown a block diagram of a second embodiment of an optical RZ signal generator according to the present invention.

This embodiment has an electric data signal input terminal 101 and an optical output port 102 in the same manner as for the first embodiment, among which a steady-state power laser light source 103 and a Mach-Zehnnder optical modulator 104 are arranged. Furthermore, the second embodiment has a low-pass filter 401 so as to have a constitution in which a binary voltage signal DIN2 for performing intensity modulation inputted to the electric data signal input terminal 101 is supplied to the Mach-Zehnnder optical modulator 104 via the low-pass filter 401.

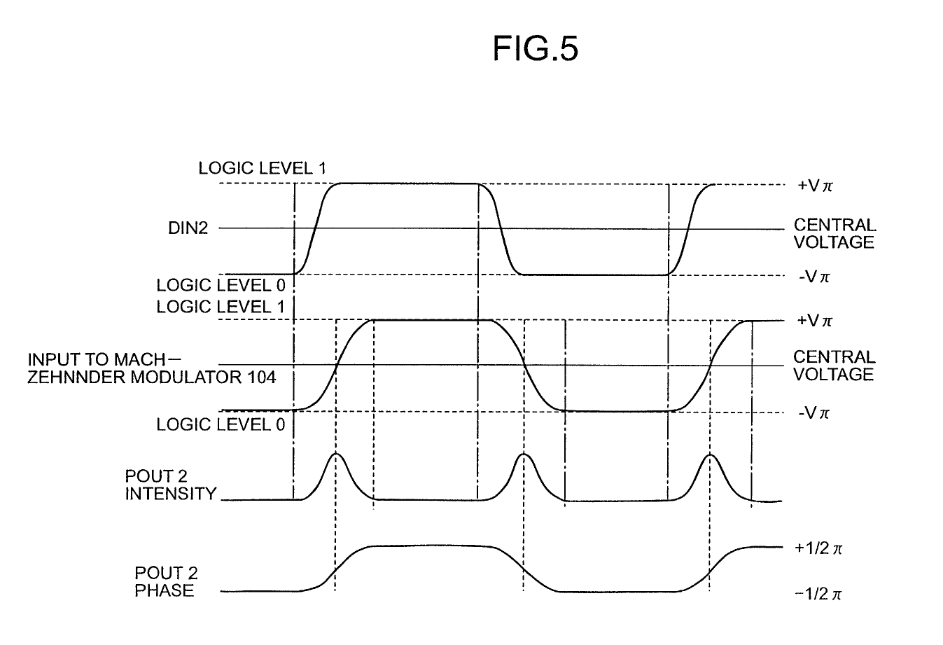

Referring to FIG. 5, there is shown a timing chart of assistance in explaining an operation of this embodiment.

The binary voltage signal DIN2 for performing intensity modulation inputted to the electric data signal input terminal 101 is preset so that insertion loss of the Mach-Zehnnder optical modulator 104 is sequentially put in the maximum state, the minimum state, and then the maximum state again in a transition process from the logic level 0 to the logic level 1 or from the logic level 1 to the logic level 0 in the same manner as for the first embodiment.

In this constitution, the optical output port 102 outputs a signal POUT2 having an optical pulse at a logic level transition of the binary voltage signal DIN2 in the same manner as for the first embodiment.

A width of the optical pulse outputted from the optical output port 102 depends on a time period required for a logic level transition of the binary voltage signal DIN2 supplied to the Mach-Zehnnder optical modulator 104. Therefore by adjusting a signal band of the binary voltage signal DIN2 with an arrangement of the low-pass filter 401, it becomes possible to change the time period required for the logic level transition of the binary voltage signal DIN2 outputted from the low-pass filter 401, by which the width of the optical pulse can be adjusted to be increased or decreased.

According to this constitution of the second embodiment, it becomes possible to achieve an optical RZ signal generator comprising a significantly less number of components in comparison with the conventional one in the same manner as the first embodiment. Furthermore, a width of the optical pulse outputted from the optical output port 102 can be determined based on a setting of the low-pass filter 401, thereby avoiding an effect of unevenness of characteristics of optical components.

[Third Embodiment]

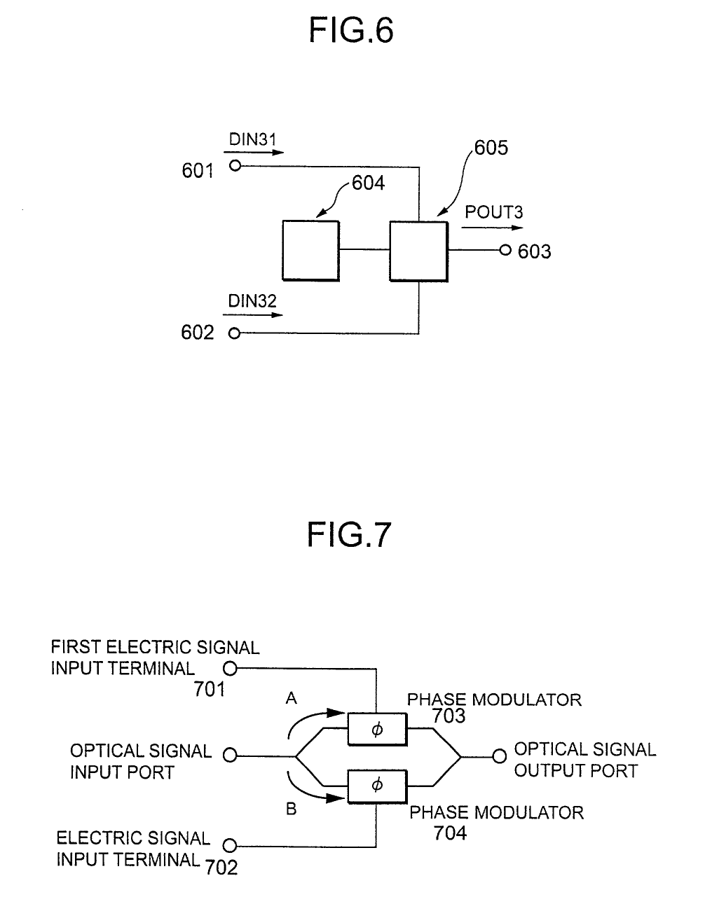

Referring to FIG. 6, there is shown a block diagram of a third embodiment of an optical RZ signal generator according to the present invention. The optical RZ signal generator of this embodiment has an electric data signal input terminal 601, a negative-phase electric data signal input terminal 602, and an optical output port 603.

A steady-state power laser light source 604 and a Mach-Zehnnder optical modulator 605 are arranged among them.

The electric data signal input terminal 601 is connected to a first electric signal input terminal of the Mach-Zehnnder optical modulator 605 and a negative-phase electric data signal input terminal 602 is connected to a second electric signal input terminal of the Mach-Zehnnder optical modulator 605.

An optical signal output port of the steady-state power laser light source 604 is connected to an optical signal input port of the Mach-Zehnnder optical modulator 605, first. Then, this Mach-Zehnnder optical modulator 605 is connected to an optical output port 603.

Referring to FIG. 7, there is shown a constitutional diagram of a differentially-driving Mach-Zehnnder optical modulator used as the Mach-Zehnnder optical modulator 605 in this embodiment. As shown in this diagram, the first electric signal input terminal 701 is connected to a phase modulator 703 arranged in the optical path (A) side of a Mach-Zehnnder interferometer and the second electric signal input terminal 702 is connected to a phase modulator 704 arranged in the optical path (B) side of the Mach-Zehnnder interferometer. As apparent from the above description, the differentially-driving Mach-Zehnnder optical modulator used in this embodiment of the optical time division multiplexer has each phase modulator in both of the optical paths unlike a general Mach-Zehnnder optical modulator having a phase modulator only in one of the optical paths of the Mach-Zehnnder interferometer.

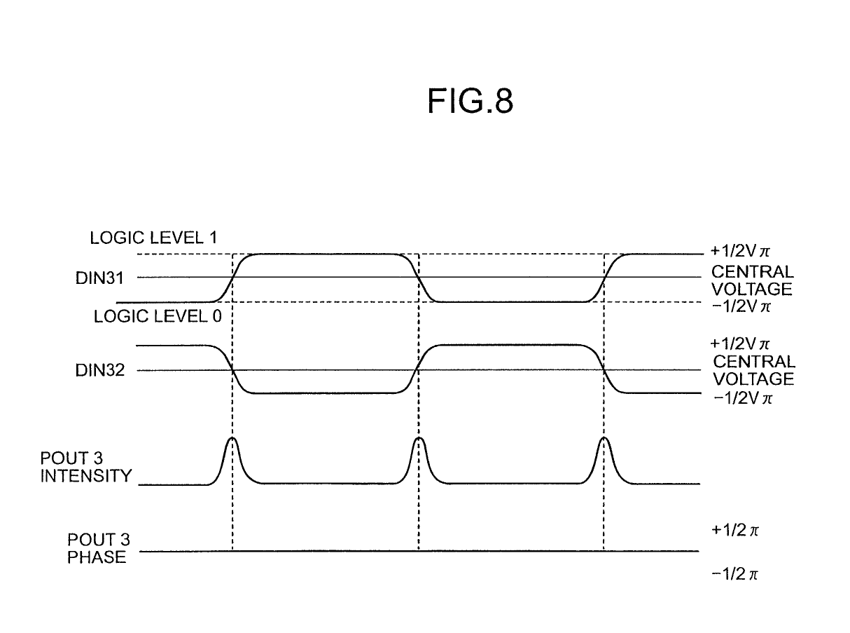

Referring to FIG. 8, there is shown a timing chart of assistance in explaining an operation of this embodiment.

A binary voltage signal DIN31 for performing intensity modulation is inputted to the electric data signal input terminal 601. An amplitude of this binary voltage signal DIN31 is equal to a voltage Vp required for p modulation, namely, for π (180 deg) modulation of a phase of a light propagating in the optical path (A) side shown in FIG. 7 of the Mach-Zehnnder optical modulator 605. On the other hand, a binary voltage signal DIN32 having a negative phase to that of the above binary voltage signal DIN31 is inputted to the negative-phase electric data signal input terminal 602. An amplitude of this binary voltage signal DIN32 is also equal to a voltage Vp required for p modulation of a light propagating in the optical path (B) side shown in FIG. 7 of the Mach-Zehnnder optical modulator 605.

A central voltage of an amplitude of the binary voltage signal DIN31 and of the negative-phase binary voltage signal DIN32 is preset to a voltage at which there is no phase difference between two optical paths in the Mach-Zehnnder optical modulator 605 so that insertion loss is minimized.

As a result, if the binary voltage signal DIN31 has the logic level 0 or the logic level 1, the insertion loss of the Mach-Zehnnder optical modulator 605 is put in the maximum state.

If the binary voltage signal DIN31 shifts from the logic level 0 to the logic level 1 or from logic level 1 to the logic level 0, the binary voltage signal DIN31 passes through the above central voltage in the transition process. As a result, the insertion loss of the Mach-Zehnnder optical modulator 605 is sequentially put in the first maximum state, the second minimum state, and then the maximum state again.

In this constitution, the optical output port 603 outputs a signal POUT3 having an optical pulse at the logic level transition of the binary voltage signal DIN31.

According to a constitution of the third embodiment, it becomes possible to achieve an optical RZ signal generator comprising a significantly less number of components in comparison with the conventional one in the same manner as for the first embodiment. Furthermore, the differentially-driving Mach-Zehnnder optical modulator 605 is driven by a complementary binary voltage signal, by which it is possible to generate an optical RZ pulse free of chirping as shown in “POUT3 phase” in FIG. 8.

[Fourth Embodiment]

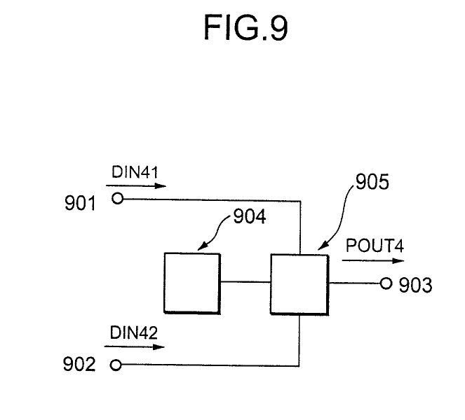

Referring to FIG. 9, there is shown a block diagram of a fourth embodiment of an optical RZ signal generator according to the present invention. This embodiment has a constitution similar to that of the third embodiment, having a first electric data signal input terminal 901, a second electric data signal input terminal 902, and an optical output port 903, among which there are arranged a steady-state power laser light source 904 and a Mach-Zehnnder optical modulator 905.

There is the most significant difference between the fourth embodiment and the third embodiment in that the third embodiment has a constitution in which the negative-phase electric data signal input terminal 602 receives an input of a binary voltage signal DIN32 having a negative phase to that of the binary voltage signal DIN31 inputted to the electric data signal input terminal 601, while the fourth embodiment has a constitution which allows a first binary voltage signal DIN41 inputted to a first electric data signal input terminal 901 and a second binary voltage signal DIN42 inputted to a second electric data signal input terminal 902 to shift from one state to the other independently of each other.

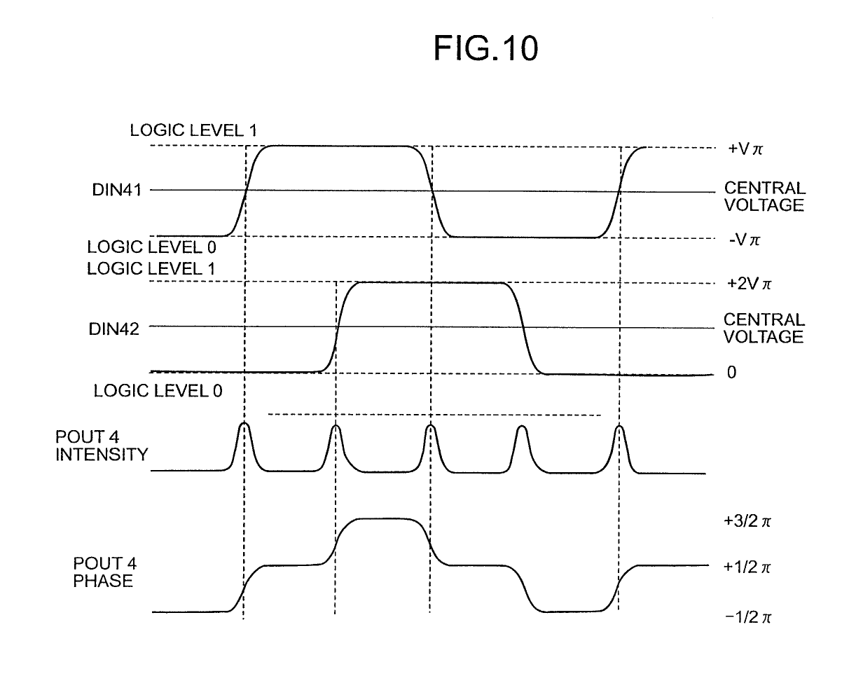

Referring to FIG. 10, there is shown a timing chart of assistance in explaining an operation of this embodiment.

The first binary voltage signal DIN41 for performing intensity modulation is inputted to the first electric data signal input terminal 901. An amplitude of the first binary voltage signal DIN41 is twice that of a voltage Vp required for p modulation of a phase of a light propagating in the optical path (A) side of the Mach-Zehnnder optical modulator 905.

In the same manner, the second binary voltage signal DIN42 for performing intensity modulation is inputted to the second electric data signal input terminal 902. An amplitude of the second binary voltage signal DIN42 is also twice that of a voltage Vp required for p modulation of a phase of a light propagating in the optical path (B) side of the Mach-Zehnnder optical modulator 905.

A central voltage of the first binary voltage signal DIN41 and a central voltage of the second binary voltage signal DIN42 are preset each to a voltage at which there is no phase difference between two optical paths in the Mach-Zehnnder optical modulator 905 so that insertion loss is minimized. Furthermore, a bit rate of the first binary voltage signal DIN41 is equal to that of the second binary voltage signal DIN42, with the second binary voltage signal DIN42 having a delay of a time period equal to one-half of a bit cycle relative to the first binary voltage signal DIN41.

As a result, if the first binary voltage signal DIN41 has the logic level 0 or the logic level 1, the insertion loss of the Mach-Zehnnder optical modulator 905 is put in the maximum state. In the same manner, if the second binary voltage signal DIN13 has the logic level 0 or the logic level 1, the insertion loss of the Mach-Zehnnder optical modulator 905 is also put in the maximum state.

If the second binary voltage signal DIN13 shifts from the logic level 0 to the logic level 1 or from the logic level 1 to the logic level 0 while the first binary voltage signal DIN41 keeps the logic level 0 or the logic level 1, the second binary voltage signal DIN42 passes through the above-described central voltage during the transition process. As a result, the insertion loss of the Mach-Zehnnder optical modulator 905 is sequentially put in the first maximum state, the second minimum state, and then the maximum state again.

In the same manner, if the first binary voltage signal DIN41 shifts from the logic level 0 to the logic level 1 or from the logic level 1 to the logic level 0 while the second binary voltage signal DIN42 keeps the logic level 0 or the logic level 1, the first binary voltage signal DIN41 passes through the above-described central voltage during the transition process. As a result, the insertion loss of the Mach-Zehnnder optical modulator 905 is sequentially put in the first maximum state, the second minimum state, and then the maximum state again.

In this constitution, the optical output port 903 outputs a signal POUT4 having an optical pulse at the logic level transition of the first binary voltage signal DIN41 or the second binary voltage signal DIN42.

According to a constitution of the fourth embodiment, it becomes possible to achieve an optical RZ signal generator comprising a significantly less number of components in comparison with the conventional one in the same manner as for the above embodiment.

Furthermore, the optical RZ signal generator of this embodiment generates an optical pulse individually at the logic level transition of the first binary voltage signal DIN41 and at the logic level transition of the second binary voltage signal DIN42, by which optical pulses can be generated in time division multiplexing processing with the first binary voltage signal DIN41 and the second binary voltage signal DIN42.

Therefore, a bit rate of the electric signal required for generating an optical RZ signal of a predetermined bit rate can be lowered to one-half of it, thereby reducing a load on an operation speed for generating an electric signal.

[Fifth Embodiment]

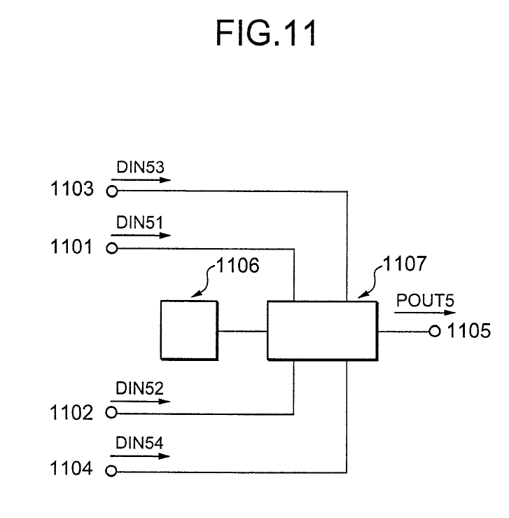

Referring to FIG. 11, there is shown a block diagram of a fifth embodiment of an optical RZ signal generator according to the present invention.

The optical RZ signal generator of this embodiment has a first electric data signal input terminal 1101 and a first negative-phase electric data signal input terminal 1102 corresponding thereto, a second electric data signal input terminal 1103 and a second negative-phase electric data signal input terminal 1104 corresponding thereto, and an optical output port 1105.

A steady-state power laser light source 1106 and a Mach-Zehnnder optical modulator 1107 are arranged among them.

The first electric data signal input terminal 1101, the first negative-phase electric data signal input terminal 1102, the second electric data signal input terminal 1103, and the second negative-phase electric data signal input terminal 1104 are connected to the Mach-Zehnnder optical modulator 1107.

An optical signal output port of the steady-state power laser light source 1106 is connected to an optical signal input port of the Mach-Zehnnder optical modulator 1107. An optical signal output port of the Mach-Zehnnder optical modulator 1107 is connected to an optical output port 1105.

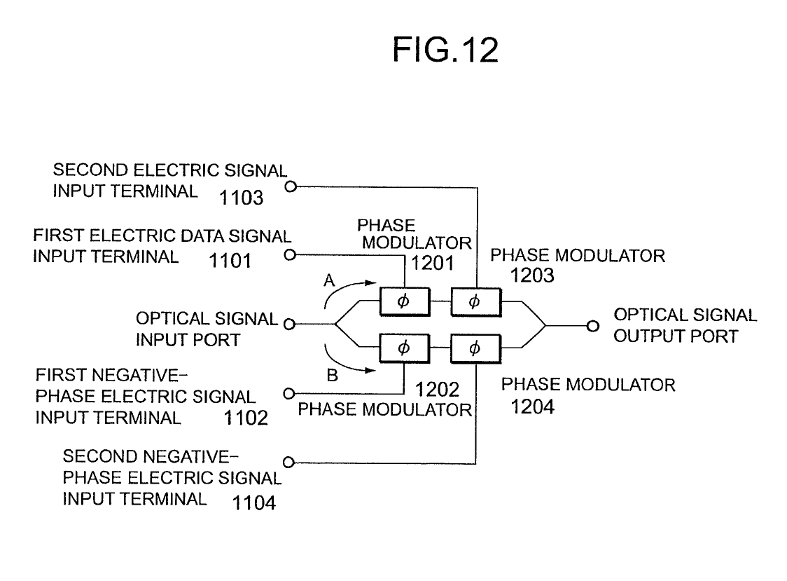

Referring to FIG. 12, there is shown a constitutional diagram of a tetrode Mach-Zehnnder optical modulator used as the Mach-Zehnnder optical modulator 1107 of this embodiment.

As shown in this diagram, the first electric signal input terminal 1101 is connected to a phase modulator 1201 arranged in the optical path (A) side of a Mach-Zehnnder interferometer and the first electric signal input terminal 1102 is connected to a phase modulator 1202 arranged in the optical path (B) side of the Mach-Zehnnder interferometer.

In the same manner, the second electric data signal input terminal 1103 is connected to a phase modulator 1203 arranged in the optical path (A) side of the Mach-Zehnnder interferometer and the second negative-phase electric data signal input terminal 1104 is connected to the phase modulator 1204 arranged in the optical path (B) side of the Mach-Zehnnder interferometer.

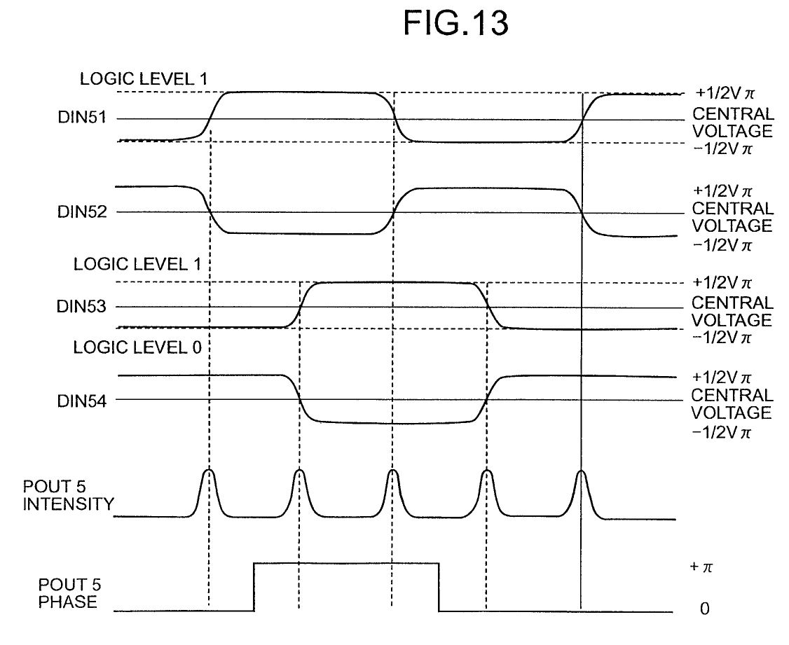

Referring to FIG. 13, there is shown a timing chart of assistance in explaining an operation of this embodiment.

A first binary voltage signal DIN51 for performing intensity modulation is inputted to the first electric data signal input terminal 1101. An amplitude of the first binary voltage signal DIN51 is equal to a voltage Vp required for p modulation of a phase of a light propagating in the optical path (A) side shown in FIG. 12 of the Mach-Zehnnder optical modulator 1107. On the other hand, a binary voltage signal DIN52 having a negative phase to that of the above first binary voltage signal DIN51 is inputted to the first negative-phase electric data signal input terminal 1102. An amplitude of this binary voltage signal DIN52 is also equal to a voltage Vp required for p modulation of a light propagating in the optical path (B) side shown in FIG. 12 of the Mach-Zehnnder optical modulator 1107.

Furthermore, the second binary voltage signal DIN53 for performing intensity modulation is inputted to the second electric data signal input terminal 1103. An amplitude of the second binary voltage signal DIN53 is also equal to the voltage Vp required for p modulation of a phase of a light propagating in the optical path (A) side of the Mach-Zehnnder optical modulator 1107. On the other hand, a binary voltage signal DIN54 having a negative phase to that of the second binary voltage signal DIN53 is inputted to the second negative-phase electric data signal input terminal 1104. An amplitude of this binary voltage signal DIN54 is also equal to the voltage Vp required for p modulation of a phase of a light propagating in the optical path (B) side of the Mach-Zehnnder optical modulator 1107.

Each central voltage of an amplitude of the first binary voltage signal DIN51, the first negative-phase binary voltage signal DIN52, the second binary voltage signal DIN53, and the second negative-phase binary voltage signal DIN54 is preset to a voltage at which there is no phase difference between two optical paths in the Mach-Zehnnder optical modulator 1107 so that insertion loss is minimized.

Furthermore, a bit rate of the first binary voltage signal DIN51 is equal to that of the second binary voltage signal DIN53, with the second binary voltage signal DIN53 having a delay of a time period equal to one-half of the bit cycle relative to the first binary voltage signal DIN51.

As a result, if the first binary voltage signal DIN51 has the logic level 0 or the logic level 1, the insertion loss of the Mach-Zehnnder optical modulator 1107 is put in the maximum state. In the same manner, if the second binary voltage signal DIN53 has the logic level 0 or the logic level 1, the insertion loss of the Mach-Zehnnder optical modulator 1107 is put in the maximum state.

If the second binary voltage signal DIN53 shifts from the logic level 0 to the logic level 1 or from logic level 1 to the logic level 0 while the first binary voltage signal DIN51 keeps the logic level 0 or the logic level 1, the second binary voltage signal DIN53 passes through the above central voltage in the transition process. As a result, the insertion loss of the Mach-Zehnnder optical modulator 1107 is sequentially put in the first maximum state, the second minimum state, and then the maximum state again.

In the same manner, if the first binary voltage signal DIN51 shifts from the logic level 0 to the logic level 1 or from logic level 1 to the logic level 0 while the second binary voltage signal DIN53 keeps the logic level 0 or the logic level 1, the first binary voltage signal DIN51 passes through the above central voltage in the transition process. As a result, the insertion loss of the first Mach-Zehnnder optical modulator 1107 is sequentially put in the first maximum state, the second minimum state, and then the maximum state again.

In this constitution, the optical output port 1105 outputs a signal POUT5 having an optical pulse at the logic level transition of the first binary voltage signal DIN51 or the second binary voltage signal DIN53.

According to the fifth embodiment, it becomes possible to achieve an optical RZ signal generator comprising a significantly less number of components in comparison with the conventional one since the generator comprises the tetrode Mach-Zehnnder optical modulator 1107 and the steady-state power laser light source 1106.

Furthermore, the optical RZ signal generator of this embodiment is capable of generating optical pulses by time division multiplexing processing by using the first binary voltage signal DIN51 and the second binary voltage signal DIN53 in the same manner as for the fourth embodiment.

Therefore, a bit rate of the electric signal required for generating an optical RZ signal having a predetermined bit rate can be decreased to one-half, thereby reducing a load on an operation speed for generating an electric signal.

Furthermore, the tetrode Mach-Zehnnder optical modulator 1107 is driven by complementary binary voltage signals such as the first binary voltage signal DIN51, its corresponding negative-phase binary voltage signal DIN52, the second binary voltage signal DIN53, and its corresponding negative-phase binary voltage signal DIN54, by which it becomes possible to generate optical RZ pulses free of chirping as shown in “POUT5 phase” in FIG. 13.

[Sixth Embodiment]

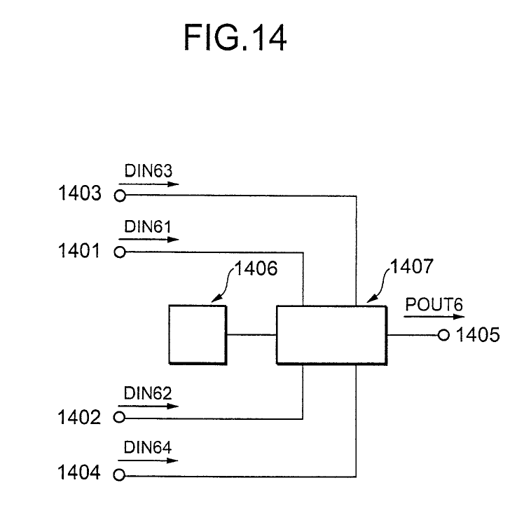

Referring to FIG. 14, there is shown a block diagram of a sixth embodiment of an optical RZ signal generator according to the present invention. This embodiment has a constitution similar to that of the fifth embodiment, having a first electric data signal input terminal 1401, a first negative-phase electric data signal input terminal 1402, a second electric data signal input terminal 1403, a second negative-phase electric data signal input terminal 1404, and an optical output port 1405, among which there are arranged a steady-state power laser light source 1406 and a tetrode Mach-Zehnnder optical modulator 1407.

There is a difference between the sixth embodiment and the fifth embodiment in that the fifth embodiment has a constitution in which the central voltage of each amplitude of the first binary voltage signal DIN51, the negative-phase binary voltage signal DIN52, the second binary voltage signal DIN53, and the negative-phase binary voltage signal DIN54 is preset to a voltage at which there is no phase difference between two optical paths in the Mach-Zehnnder optical modulator 1107 so that the insertion loss is minimized, while the sixth embodiment has a constitution in which the central voltage of each amplitude of a first binary voltage signal DIN61, a negative-phase binary voltage signal DIN62, a second binary voltage signal DIN63, and a negative-phase binary voltage signal DIN64 to be supplied to a first electric data signal input terminal 1401, a first negative-phase electric data signal input terminal 1402, a second electric data signal input terminal 1403, and a second negative-phase electric data signal input terminal 1404, respectively is preset to a voltage at which there occurs a phase difference of π between two optical paths in a Mach-Zehnnder optical modulator 1407 so that the insertion loss is maximized.

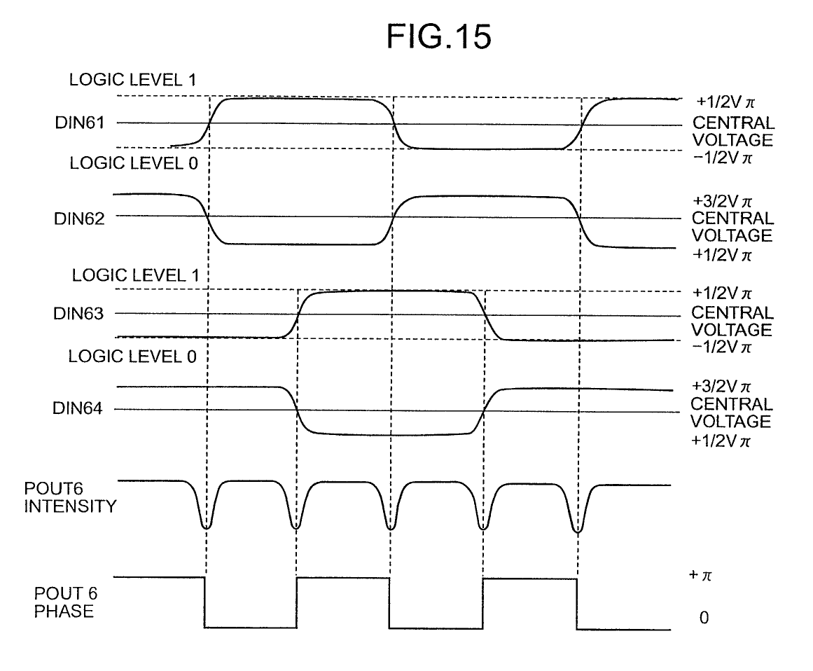

As a result, as shown in FIG. 15 which is a timing chart of assistance in explaining an operation of this embodiment, if the first binary voltage signal DIN61 or the second binary voltage signal DIN63 shifts from the logic level 0 to the logic level 1 or from the logic level 1 to the logic level 0, the insertion loss of the Mach-Zehnnder optical modulator 1407 is sequentially put in the minimum state, the maximum state, and then the minimum state again in the transition process.

In this constitution, the optical output port 1405 outputs a signal POUT6 extinguishing light at the logic level transition of the first binary voltage signal DIN61 or the second binary voltage signal DIN63.

According to a constitution of the sixth embodiment, the optical RZ signal generator comprises a tetrode Mach-Zehnnder optical modulator 1407 and a steady-state power laser light source 1406 in the same manner as for the fifth embodiment, by which it becomes possible to achieve an optical RZ signal generator comprising a significantly less number of components in comparison with the conventional one and capable of generating optical RZ pulses free of chirping.

Furthermore, the optical RZ signal generator of this embodiment is capable of generating optical pulses in time division multiplexing processing with the first binary voltage signal DIN61 and the second binary voltage signal DIN63 in the same manner as for the fourth and fifth embodiments, thereby reducing a load on an operation speed for generating electric signals.

In addition, an optical signal POUT6 outputted from the optical output port 1405 becomes an optical duobinary signal and therefore it has a narrow optical band, by which a tolerance for a wavelength dispersion is high advantageously.

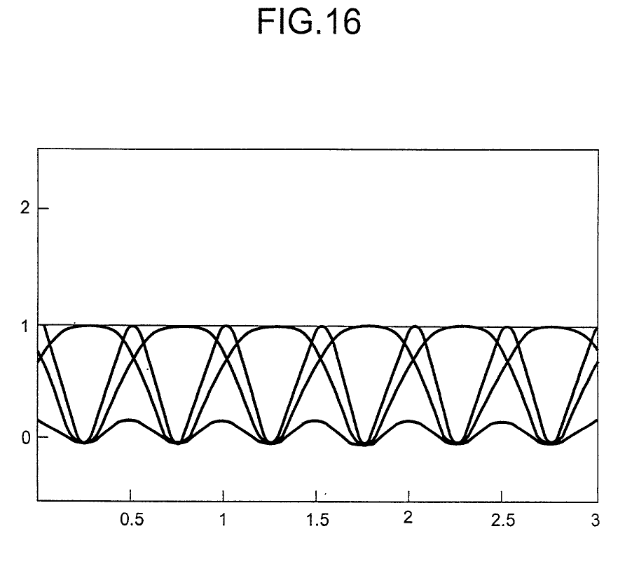

Referring to FIG. 16, there is shown an example of an optical output waveform according to the sixth embodiment. If signal bands of the first binary voltage signal DIN61, the first negative-phase binary voltage signal DIN62, the second binary voltage signal DIN63, and the second negative-phase binary voltage signal DIN64 are wide (rapid transition), the optical waveform becomes sharp downward as shown in FIG. 15. On the other hand, if the signal band is narrow, a width of the optical waveform which has been sharp downward is increased gradually; if it becomes too wide, a penalty may occur due to an interference with an adjacent bit.

It is said that a band of an electric signal having no penalty under a condition of “the optical waveform equal to the electric waveform” requires at least three quarters of a bit frequency for a normal NRZ signal. By using a constitution of this embodiment, however, each band of the first binary voltage signal DIN61, the first negative-phase binary voltage signal DIN62, the second binary voltage signal DIN63, and the second negative-phase binary voltage signal DIN64 needed for generating waveforms as shown in FIG. 16 requires only one-half of the bit frequency of each signal and therefore a load on an operation speed for generating electric signals is further reduced in comparison with the above embodiments.

The characteristics in respective constitutions of the embodiments set forth in the above can be appropriately combined with each other. For example, the low-pass filter used in the second embodiment can be used between each electric data signal input terminal and each Mach-Zehnnder optical modulator of the third and sixth embodiments other than the second embodiment.

In the first to fourth embodiments, the insertion loss of the Mach-Zehnnder optical modulator can be a minimum as the first state and a maximum as the second state in respective constitutions, and setting is previously made so that the insertion loss is put in the first maximum state, the second minimum state, and then the maximum state again sequentially in the logic level transition process of the binary voltage signal. The present invention, however, is not limited to this setting, but as apparent from a relationship between the fifth and sixth embodiments, it is possible to select the maximum state for the insertion loss as the first state and to select the minimum state for the insertion loss as the second state other than the first state.

Otherwise, while in the fourth, fifth, and sixth embodiments there are provided constitutions in which optical pulses are generated in the time division multiplexing processing with the first binary voltage signal and the second binary voltage signal, it is possible to generate optical pulses in time division multiplexing processing using more binary voltage signals by arranging more phase modulators on the optical paths in each Mach-Zehnnder optical modulator.

[Seventh Embodiment]

Next, a constitution is described for an optical time division multiplexer according to the present invention for generating time-division multiplexed optical pulses.

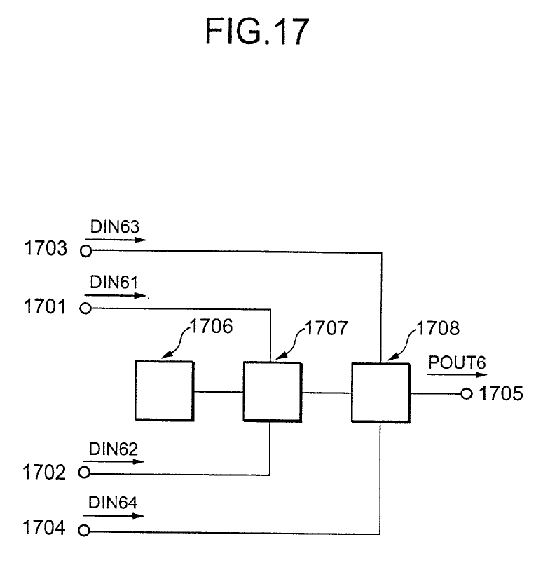

Referring to FIG. 17, there is shown a block diagram illustrating a seventh embodiment of an optical time division multiplexer according to the present invention. The time division multiplexer shown in FIG. 17 has a constitution for time division multiplexing by bit interleaving with first and second time slots arranged in a single signal band.

This optical time division multiplexer has a first electric data signal input terminal 1701 and a first negative-phase electric data signal input terminal 1702 corresponding thereto, a second electric data signal input terminal 1703 and a second negative-phase electric data signal input terminal 1704 corresponding thereto, and an optical output port 1705.

A steady-state power laser light source 1706, a first Mach-Zehnnder optical modulator 1707, and a second Mach-Zehnnder optical modulator 1708 are arranged among them.

The first electric data signal input terminal 1701 is connected to a first electric signal input terminal of the first Mach-Zehnnder optical modulator 1707, and the first negative-phase electric data signal input terminal 1702 is connected to a second electric signal input terminal of the first Mach-Zehnnder optical modulator 1707.

In the same manner, the second electric data signal input terminal 1703 is connected to a first electric signal input terminal of the second Mach-Zehnnder optical modulator 1708, and the second negative-phase electric data signal input terminal 1704 is connected to a second electric signal input terminal of the second Mach-Zehnnder optical modulator 1708.

An optical signal output port of the steady-state power laser light source 1706 is connected to an optical signal input port of the first Mach-Zehnnder optical modulator 1707. An optical signal output port of the first Mach-Zehnnder optical modulator 1707 is connected to an optical signal input port of the second Mach-Zehnnder optical modulator 1708. An optical signal output port 1705 of the second Mach-Zehnnder optical modulator 1708 is connected to the optical output port 1705.

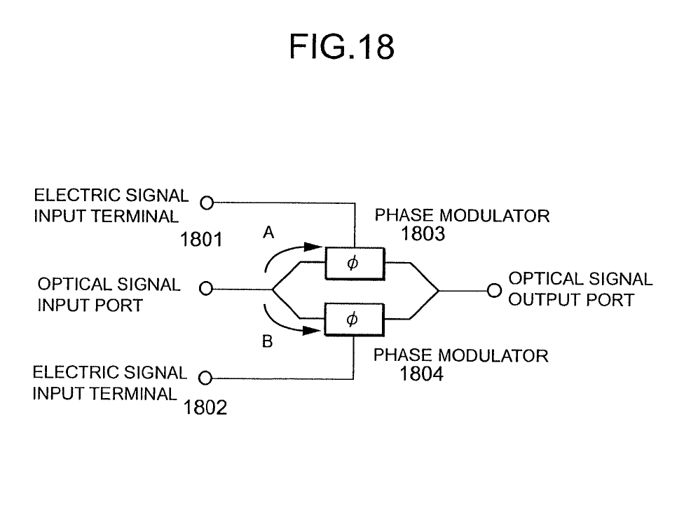

Referring to FIG. 18, there is shown a constitutional diagram of a differentially-driving Mach-Zehnnder optical modulator used as the first Mach-Zehnnder optical modulator 1707 and the second Mach-Zehnnder optical modulator 1708 in this embodiment of this optical time division multiplexer. As shown in this diagram, the electric signal input terminal 1801 is connected to a phase modulator 1803 arranged in the optical path (A) side of a Mach-Zehnnder interferometer and the electric signal input terminal 1802 is connected to a phase modulator 1804 arranged in the optical path (B) side of the Mach-Zehnnder interferometer.

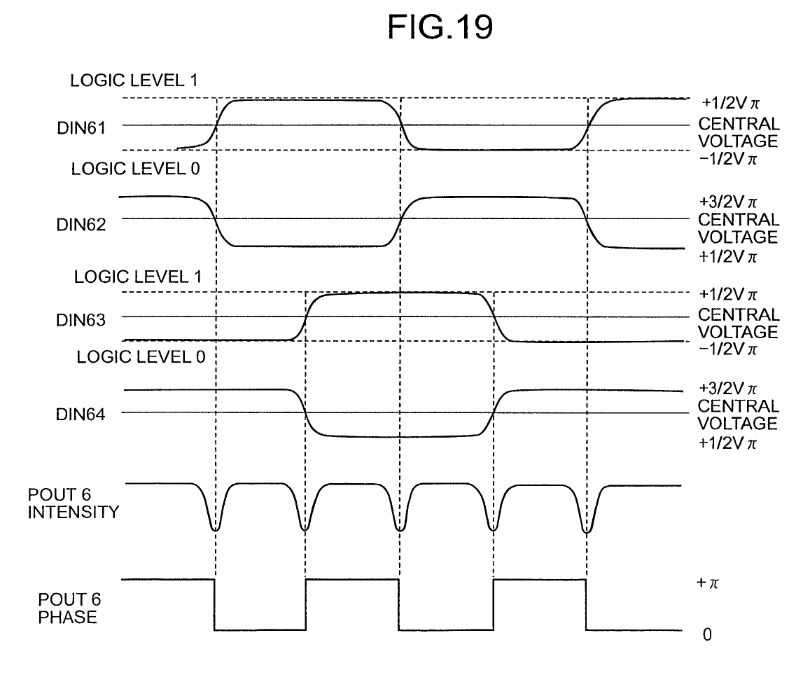

Referring to FIG. 19, there is shown a timing chart of assistance in explaining an operation of the sixth embodiment.

A first binary voltage signal DIN61 for performing intensity modulation is inputted to the first electric data signal input terminal 1701. An amplitude of the first binary voltage signal DIN61 is equal to a voltage Vp required for p modulation of a phase of a light propagating in the optical path (A) side shown in FIG. 18 of the first Mach-Zehnnder optical modulator 1707. On the other hand, a binary voltage signal DIN62 having a negative phase to that of the above first binary voltage signal DIN61 is inputted to the first negative-phase electric data signal input terminal 1702. An amplitude of this binary voltage signal DIN62 is also equal to a voltage Vp required for p modulation of a light propagating in the optical path (B) side shown in FIG. 18 of the first Mach-Zehnnder optical modulator 1707.

Furthermore, the second binary voltage signal DIN63 for performing intensity modulation is inputted to the second electric data signal input terminal 1703. An amplitude of the second binary voltage signal DIN63 is also equal to the voltage Vp required for p modulation of a phase of a light propagating in the optical path (A) side shown in FIG. 18 of the Mach-Zehnnder optical modulator 1708. On the other hand, a binary voltage signal DIN64 having a negative phase to that of the second binary voltage signal DIN63 is inputted to the second negative-phase electric data signal input terminal 1704. An amplitude of this binary voltage signal DIN64 is also equal to the voltage Vp required for p modulation of a phase of a light propagating in the optical path (B) side shown in FIG. 18 of the second Mach-Zehnnder optical modulator 1708.

Each central voltage of an amplitude of the first binary voltage signal DIN61 and the negative-phase binary voltage signal DIN62 is preset to a voltage at which there occurs a phase difference of π between two optical paths in the first Mach-Zehnnder optical modulator 1707 so that insertion loss is maximized. In the same manner, each central voltage of an amplitude of the second binary voltage signal DIN63 and the negative-phase binary voltage signal DIN64 is preset to a voltage at which insertion loss of the second Mach-Zehnnder optical modulator 1708 is maximized. Furthermore, a bit rate of the first binary voltage signal DIN61 is equal to that of the second binary voltage signal DIN63, with the second binary voltage signal DIN63 having a delay of a time period equal to one-half of the bit cycle relative to the first binary voltage signal DIN61.

As a result, if the first binary voltage signal DING61 has the logic level 0 or the logic level 1, the insertion loss of the first Mach-Zehnnder optical modulator 1707 is put in the minimum state. In the same manner, if the second binary voltage signal DIN63 has the logic level 0 or the logic level 1, the insertion loss of the second Mach-Zehnnder optical modulator 1708 is put in the minimum state.

If the second binary voltage signal DIN63 shifts from the logic level 0 to the logic level 1 or from logic level 1 to the logic level 0 while the first binary voltage signal DIN61 keeps the logic level 0 or the logic level 1, the second binary voltage signal DIN63 passes through the above central voltage in the transition process. As a result, the insertion loss of the second Mach-Zehnnder optical modulator 1708 is sequentially put in the minimum state, the maximum state, and then the minimum state again.

In the same manner, if the first binary voltage signal DIN61 shifts from the logic level 0 to the logic level 1 or from logic level 1 to the logic level 0 while the second binary voltage signal DIN63 keeps the logic level 0 or the logic level 1, the first binary voltage signal DIN61 passes through the above central voltage in the transition process. As a result, the insertion loss of the first Mach-Zehnnder optical modulator 1707 is sequentially put in the minimum state, the maximum state, and then the minimum state again.

In this constitution in which the insertion loss shifts from the first low level to the second higher level and then returns to the first level, the optical output port 1705 outputs a signal POUT6 extinguishing a light at the logic level transition of the first binary voltage signal DIN61 or the second binary voltage signal DIN63.

As apparent from the above description, in this embodiment of the optical time division multiplexer, a time-division multiplexed optical signal comprising first and second time slots can be generated by shifting the logic level of the first binary voltage signal DIN61 and the logic level of the second binary voltage signal DIN63 to a period equivalent to each time slot (a position on a time axis of each bit after multiplexing).

In addition, the embodiment of the optical time division multiplexer comprises, as apparent from the constitution shown in FIG. 17, the first Mach-Zehnnder optical modulator 1707, the second Mach-Zehnnder optical modulator 1708, and the steady-state power laser light source 1706, thereby having no need for using optical components such as a branching filter and an optical combiner required for the conventional one and therefore significantly reducing the number of components.

The first Mach-Zehnnder optical modulator 1707 and the second Mach-Zehnnder optical modulator 1708 are differentially-driving Mach-Zehnnder optical modulators, and these are complementarily driven by using the first binary voltage signal DIN61 and its corresponding negative-phase binary voltage signal DIN62 or the second binary voltage signal DIN63 and its corresponding negative-phase binary voltage signal DIN64. Therefore, the first Mach-Zehnnder optical modulator 1707 and the second Mach-Zehnnder optical modulator 1708 are capable of performing optical modulation free of chirping for inputted optical signals, and therefore a use of the constitution of this embodiment of the optical time division multiplexer makes it possible to generate optical signals free of chirping.

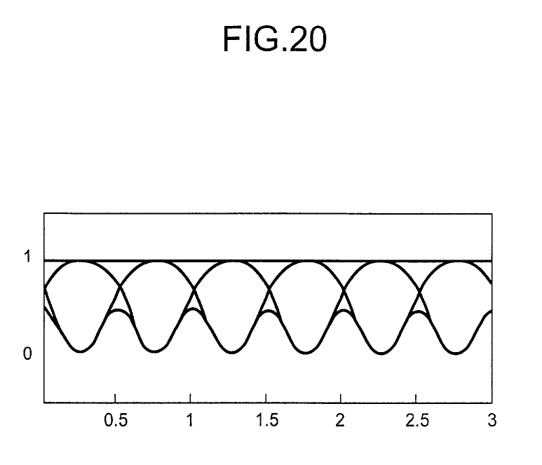

Furthermore, giving an example of bands of the first binary voltage signal DIN61, its corresponding negative-phase binary voltage signal DIN62, the second binary voltage signal DIN63, and its corresponding negative-phase binary voltage signal DIN64 required for generating waveforms as shown in FIG. 20, a transition of the first binary voltage signal DIN61 and its negative-phase binary voltage signal DIN62 from the logic level 1 to the logic level 0 and a transition thereof from the logic level 0 to the logic level 1 occur only in odd-numbered time slots, while a transition of the second binary voltage signal DIN63 and its negative-phase binary voltage signal DIN64 from the logic level 1 to the logic level 0 and a transition thereof from the logic level 0 to the logic level 1 occur only in even-numbered time slots. In other words, each bit frequency of the first binary voltage signal DIN61, its negative-phase binary voltage signal DIN62, the second binary voltage signal DIN63, and its negative-phase binary voltage signal DIN64 can be one-half of a time slot frequency of the output optical signal. This reduces a load on the operation speed of the electric circuit side for generating electric signals.

In addition, an optical signal outputted from the optical output port 1705 becomes an optical duobinary signal having different optical phases of adjacent time slots with odd-numbered extinct time slots put therebetween and having equal optical phases of adjacent time slots with even-numbered extinct time slots put therebetween. Therefore, a use of the constitution of this embodiment of the optical time division multiplexer makes it possible to achieve effects of narrowing optical bands, increasing a tolerance for a wavelength dispersion, and improving a band utilization efficiency in the wavelength division multiplexing transmission.

While the differentially-driving first Mach-Zehnnder optical modulator 1707 and the second Mach-Zehnnder optical modulator 1708 are used as the first external intensity modulator and the second external intensity modulator in the above seventh embodiment, it is also possible to use a single-phase Mach-Zehnnder optical modulator having a phase modulator only on one optical path in the present invention. A use of this single-phase Mach-Zehnnder optical modulator simplifies a circuit for generating binary voltage signals. The single-phase Mach-Zehnnder optical modulator, however, requires a driving amplitude of 2 Vπ, while the differential one only requires a driving amplitude of Vp. Therefore by selecting a type of a modulator in which an output light is submitted only to intensity modulation (equivalent to X-Cut type for a Mach-Zehnnder optical modulator using LiNbO₃ optical crystals) as this single-phase Mach-Zehnnder optical modulator, optical signals free of chirping are achieved in the same manner as for the embodiments of the above optical time division multiplexer.

In the same manner, for the optical time division multiplexer according to the present invention, it is possible to use other external intensity modulators such as electro-absorption (EA) optical modulator. Unlike the above-described Mach-Zehnnder optical modulator, however, a duty for a binary voltage signal need be adjusted so that each of the first external intensity modulator and the second external intensity modulator can perform the intensity modulation in a single time slot width.

The second binary voltage signal DIN63 which is a second signal has a delay equal to one-half of a time period of a bit cycle relative to the first binary voltage signal DIN61 which is a first electric signal in the above embodiment of the optical time division multiplexer. It is because this embodiment of the optical time division multiplexer has a constitution for time division multiplexing with two (first and second) time slots by bit interleaving. This makes it possible to use the constitution and to input the first and second signals sequentially into the first Mach-Zehnnder optical modulator and the second Mach-Zehnnder optical modulator which are the first and second external intensity modulators for each period equivalent to the first and second time slots, respectively.

Naturally the present invention is applicable to an optical time division multiplexer having any of the first to nth (n is a 2 or greater integer) time slot other than the above embodiment of the optical time division multiplexer.

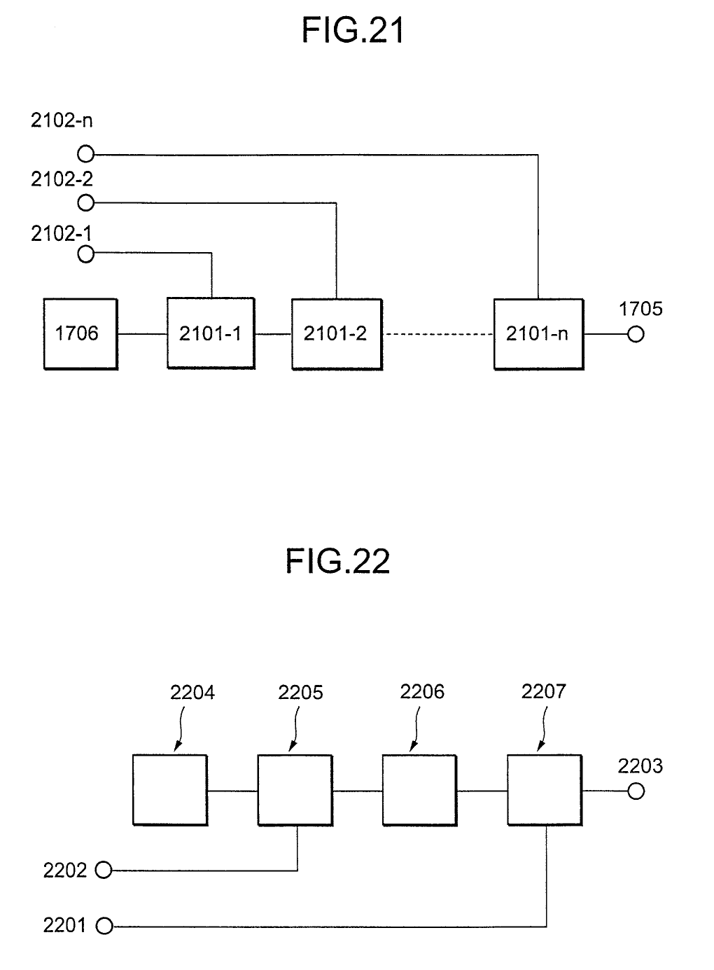

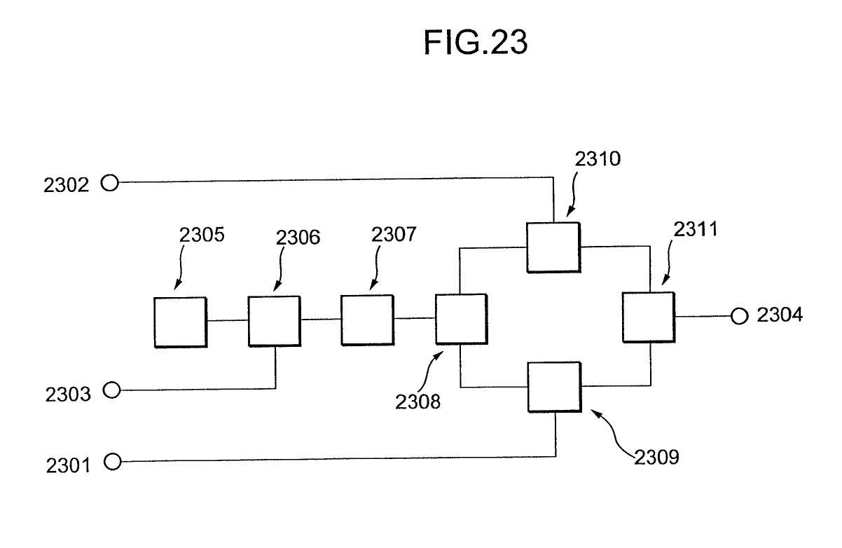

Referring to FIG. 21, there is shown a block diagram illustrating the optical time division multiplexer having the first to nth time slot, in which a first external intensity modulator 2101-1, a second external intensity modulator 2101-2, - - - and an nth external intensity modulator 2101-n are connected in series between a steady-state power laser light source 1706 and an optical output port 1705. Additionally a first electric signal input terminal 2102-1, a second electric signal input terminal 2102-2, - - - and an nth electric signal input terminal 2102-n are connected to the first external intensity modulator 2101-1, the second external intensity modulator 2101-2, - - - , and the nth external intensity modulator 2101-n, respectively.

Furthermore, by giving a predetermined delay (for example, a delay equal to 1/n of a time period of a bit cycle if respective time slot intervals are equal to each other in time division multiplexing with bit interleaving) sequentially to the first, second, and nth electric signals supplied to the first electric signal input terminal 2102-1, the second electric signal input terminal 2102-2, - - -, and the nth electric signal input terminal 2102-n, respectively, each of the corresponding first to nth external intensity modulators can execute modulation based on the first to nth electric signals inputted during a period equivalent to the first to nth time slots.

While the present invention has been described above mainly for constitutions used for time division multiplexing with bit interleaving, it is applicable to other constitutions. Furthermore, the constitution of the sixth embodiment of the above optical RZ signal generator can be applied to an optical time division multiplexer.

The constitution of the optical RZ signal generator according to the present invention makes it possible to reduce the number of components significantly in comparison with the conventional one.

In addition, the constitution of the optical time division multiplexer according to the present invention omits a need for processing of branching and combining waves which have been required in the conventional one, thereby achieving an optical time division multiplexer having a simple constitution. Furthermore, by using the Mach-Zehnnder optical modulators as the first and second external intensity modulators, optical signals free of chirping can be generated with reducing a load on an operation speed for generating electric signals.

What is claimed is:

1. An optical RZ signal generator, comprising:
a steady-state power laser light source; and
a Mach-Zehnnder optical modulator for performing intensity modulation on the basis of electric signals with being connected to an output of said steady-state power laser light source,
wherein said electric signals are binary voltage signals and insertion loss of said Mach-Zehnnder optical modulator is preset so as to shift from a first state to a second state other than the first one and then to return to the first state in a logic level transition process of the binary voltage signal.

2. An optical RZ signal generator according to claim 1,
wherein said Mach-Zehnnder optical modulator uses a first electric signal and a second electric signal as said electric signals; and
wherein said Mach-Zehnnder optical modulator is differentially-driving a Mach-Zehnnder optical modulator for modulating a phase of a light propagating in a first optical path on the basis of said first electric signal and for modulating a phase of a light propagating in a second optical path on the basis of said second electric signal.

3. An optical RZ signal generator according to claim 2, wherein said first electric signal and said second electric signal are a binary voltage signal and its negative-phase binary voltage signal.

4. An optical RZ signal generator according to claim 3, wherein an amplitude of said binary voltage signal is equivalent to a voltage required for π modulation of a phase of a light propagating in said first optical path and an amplitude of said negative-phase binary voltage signal is equivalent to a voltage required for π modulation of a phase of a light propagating in said second optical path.

5. An optical RZ signal generator according to claim 1, wherein said electric signal is supplied to said Mach-Zehnnder optical modulator via a low-pass filter.

6. An optical RZ signal generator according to claim 1,
wherein said insertion loss of said Mach-Zehnnder optical modulator is preset so that said first state is its minimum and said second state is its maximum; or
wherein said insertion loss of said Mach-Zehnnder optical modulator is preset so that said first state is its maximum and said second state is its minimum.

7. An optical RZ signal generator, comprising:
a steady-state power laser light source; and
a Mach-Zehnnder optical modulator connected to an output of said steady-state power laser light source and having a first phase modulator for modulating a phase of a light on the basis of a first electric signal and a second phase modulator for modulating a phase of a light on the basis of a second electric signal,
wherein said first electric signal and said second electric signal are binary voltage signals and wherein insertion loss of said Mach-Zehnnder optical modulator is preset so as to shift from a first state to a second state other than the first one and then to return to said first state in a logic level transition process of the binary voltage signals.

8. An optical RZ signal generator according to claim 7,
wherein said Mach-Zehnnder optical modulator is a differentially-driving Mach-Zehnnder optical modulator for modulating a phase of a light propagating in a first optical path on the basis of said first electric signal and for modulating a phase of a light propagating in a second optical path on the basis of said second electric signal;
wherein said first electric signal is a binary voltage signal having an amplitude equivalent to twice that of a voltage required for π modulation of a phase of a light propagating in said first optical path; and
wherein said second electric signal is a binary voltage signal having an amplitude equivalent to twice that of a voltage required for π modulation of a phase of a light propagating in said second optical path.

9. An optical RZ signal generator, comprising:
a steady-state power laser light source; and
a Mach-Zehnnder optical modulator having a first phase modulator for modulating a phase of a light on the basis of a first electric signal and a second phase modulator for modulating a phase of a light on the basis of a second electric signal on a first optical path and having a third phase modulator for modulating a phase of a light on the basis of a third electric signal and a fourth phase modulator for modulating a phase of a light on the basis of a fourth electric signal on a second optical path,
wherein said first electric signal and said third electric signal are a binary voltage signal and its negative-phase binary voltage signal and said second electric signal and said fourth electric signal are a binary voltage signal and its negative-phase binary voltage signal and wherein insertion loss of said Mach-Zehnnder optical modulator is preset so as to shift from a first state to a second state other than the first one and then to return to said first state in a logic level transition process of the binary voltage signals.

10. An optical RZ signal generator according to claim 9,
wherein each of said first electric signal and said second electric signal has an amplitude equivalent to a voltage required for π modulation of a phase of a light propagating in said first optical path and each of said third electric signal and said fourth electric signal has an amplitude equivalent to a voltage required for π modulation of a phase of a light propagating in said second optical path.

11. An optical time division multiplexer, comprising:
a steady-state power laser light source; and
first to nth (n is an integer of 2 or greater) external intensity modulators connected in series to an output of said steady-state power laser light source,
wherein said first to nth external intensity modulators execute intensity modulation during a period corresponding to first to nth time slots on the basis of first to nth electric signals, respectively.

12. An optical time division multiplexer according to claim 11, wherein time division multiplexing is performed by bit interleaving.

13. An optical time division multiplexer according to claim 11, wherein said external intensity modulators are Mach-Zehnnder optical modulators.

14. An optical time division multiplexer according to claim 13, wherein said electric signals are binary voltage signals and wherein each insertion loss of said Mach-Zehnnder optical modulators is preset so as to shift from a first state in which the insertion loss is low to a second state in which the insertion loss is higher and to return to said first state in a logic level transition process of the binary voltage signals.

15. An optical time division multiplexer according to claim 14, wherein said Mach-Zehnnder optical modulators are differentially-driving Mach-Zehnnder optical modulators and wherein said electric signals comprise binary voltage signals and their binary voltage signals.

16. An optical time division multiplexer according to claim 11, wherein said external intensity modulators are electro-absorption modulators.

17. An optical RZ signal generating method for generating an optical RZ signal by supplying a signal light from a steady-state power laser light source and performing intensity modulation on the basis of electric signals for said signal light using a Mach-Zehnnder optical modulator,
wherein said electric signals are binary voltage signals and insertion loss of said Mach-Zehnnder optical modulator is preset so as to shift from a first state to a second state other than the first one and then to return to said first state in a logic level transition process of the binary voltage signals.

18. An optical RZ signal generating method according to claim 17, wherein said Mach-Zehnnder optical modulator uses a first electric signal and a second electric signal as said electric signals; and
wherein said Mach-Zehnnder optical modulator is a differentially-driving Mach-Zehnnder optical modulator which modulates a phase of a light propagating in a first optical path on the basis of said first electric signal and modulates a phase of a light propagating in a second optical path on the basis of said second electric signal.

19. An optical RZ signal generating method according to claim 18, wherein said first electric signal and said second electric signal are a binary voltage signal and its negative-phase binary voltage signal.

20. An optical RZ signal generating method according to claim 19, wherein an amplitude of said binary voltage signal is equivalent to a voltage required for π modulation of a phase of a light propagating in said first optical path and an amplitude of said negative-phase binary voltage signal is equivalent to a voltage required for π modulation of a phase of a light propagating in said second optical path.

21. An optical RZ signal generating method according to claim 17, wherein said electric signal is supplied to said Mach-Zehnnder optical modulator via a low-pass filter.

22. An optical RZ signal generating method according to claim 17,
wherein said insertion loss of said Mach-Zehnnder optical modulator is preset so that said first state is its minimum and said second state is its maximum; or
wherein said insertion loss of said Mach-Zehnnder optical modulator is preset so that said first state is its maximum and said second state is its minimum.

23. An optical RZ signal generating method for generating an optical RZ signal by supplying a signal light from a steady-state power laser light source and performing intensity modulation for said signal light by using a Mach-Zehnnder optical modulator having a first phase modulator for modulating a phase of a light on the basis of a first electric signal and a second phase modulator for modulating a phase of a light on the basis of a second electric signal on optical paths,
wherein said first electric signal and said second electric signal are binary voltage signals and insertion loss of said Mach-Zehnnder optical modulator is preset so as to shift from a first state to a second state other than the first one and then to return to said first state in a logic level transition process of the binary voltage signals.

24. An optical RZ signal generating method according to claim 23,
wherein said Mach-Zehnnder optical modulator is a differentially-driving Mach-Zehnnder optical modulator for modulating a phase of a light propagating in a first optical path on the basis of said first electric signal and for modulating a phase of a light propagating in a second optical path on the basis of said second electric signal;
wherein said first electric signal is a binary voltage signal having an amplitude equivalent to twice that of a voltage required for π modulation of a phase of a light propagating in said first optical path; and
wherein said second electric signal is a binary voltage signal having an amplitude equivalent to twice that of a voltage required for π modulation of a phase of a light propagating in said second optical path.

25. An optical RZ signal generating method for generating an optical RZ signal by supplying a signal light from a steady-state power laser light source and performing intensity modulation for said signal light by using a Mach-Zehnnder optical modulator having a first phase modulator for modulating a phase of a light on the basis of a first electric signal and a second phase modulator for modulating a phase of a light on the basis of a second electric signal on a first optical path and having a third phase modulator for modulating a phase of a light on the basis of a third electric signal and a fourth phase modulator for modulating a phase of a light on the basis of a fourth electric signal on a second optical path,
wherein said first electric signal and said third electric signal are a binary voltage signal and its negative-phase binary voltage signal and said second electric signal and said fourth electric signal are a binary voltage signal and its negative-phase binary voltage signal and wherein insertion loss of said Mach-Zehnnder optical modulator is preset so as to shift from a first state to a second state other than the first one and then to return to said first state in a logic level transition process of the binary voltage signals.

26. An optical RZ signal generating method according to claim 25,
wherein each of said first electric signal and said second electric signal has an amplitude equivalent to a voltage required for π modulation of a phase of a light propagating in said first optical path and each of said third electric signal and said fourth electric signal has an amplitude equivalent to a voltage required for π modulation of a phase of a light propagating in said second optical path.

27. An optical time division multiplexing method,
wherein a signal light is supplied from a steady-state power laser light source to a first to nth (n is an integer of 2 or greater) external intensity modulators connected in series; and
wherein said first to nth external intensity modulators execute intensity modulation during a period corresponding to first to nth time slots on the basis of first to nth electric signals, respectively.

28. An optical time division multiplexing method according to claim 27, wherein time division multiplexing is performed by bit interleaving.

29. An optical time division multiplexing method according to claim 27, wherein said external intensity modulators are Mach-Zehnnder optical modulators.

30. An optical time division multiplexing method according to claim 29, wherein said electric signals are binary voltage signals and wherein each insertion loss of said Mach-Zehnnder optical modulators is preset so as to shift from a first state in which the insertion loss is low to a second state in which the insertion loss is higher and to return to said first state in a logic level transition process of the binary voltage signals.

31. An optical time division multiplexing method according to claim 30, wherein said Mach-Zehnnder optical modulators are differentially-driving Mach-Zehnnder optical modulators and wherein said electric signals comprise binary voltage signals and their binary voltage signals.

32. An optical time division multiplexing method according to claim 27, wherein said external intensity modulators are electro-absorption modulators.
